(19) United States
(12) Patent Application Publication
(10) Pub. No.: US 2015/0361953 A1
(43) Pub. Date: Dec. 17, 2015

(54) HORIZONTALLY CHANNELED VERTICAL AXIS WIND TURBINE

(71) Applicant: Imperial Wind Corporation, Yucca Valley, CA (US)

(72) Inventors: Ronald Eugene Freese, Bermuda Danes, CA (US); Cassandra Anne Jory, Yucca Valley, CA (US)

(21) Appl. No.: 14/738,773

(22) Filed: Jun. 12, 2015

Related U.S. Application Data
(60) Provisional application No. 62/011,473, filed on Jun. 12, 2014.

(51) Int. Cl. F03D 3/04; F03D 11/02; F03D 9/00; F03D 3/00; F03D 3/06

(52) U.S. Cl. CPC F03D 3/04; F03D 3/005; F03D 3/06; F03D 9/002; F03D 11/02

(57) ABSTRACT

A horizontally channeled vertical axis wind turbine for electrical power generation is provided. The wind turbine may collect ambient wind speed from between 0-+/−50 ft. above ground level. The collected wind is accelerated and concentrated within horizontal laminar flow channels which direct the accelerated and concentrated wind up and through to a smaller exhaust and a series of turbine blades, located on a vertical axis turbine and shaft, which provides power to an electrical generator or alternator located below the wind turbine. The horizontally channeled vertical axis wind turbine may comprise an ambient wind scoop structure, a horizontal laminar flow channel support structure and a self-supporting turbine disk structure. The ambient wind scoop structure may gather ambient wind and then concentrate and accelerate the wind into two (2) horizontal laminar air flow channels in the horizontal laminar flow channel support structure which is supported by the self-supporting turbine disk structure.

### CLAIM OF PRIORITY UNDER 35 U.S.C. §119

The present Application for Patent claims priority to U.S. Provisional Application No. 62/011,473 entitled “HORIZONTALLY CHANNELED VERTICAL AXIS WIND TURBINE”, filed Jun. 12, 2014, and is hereby expressly incorporated by reference herein.

### FIELD

Various features pertain to the generation of electricity through the use of a channeled wind turbine, and more specifically to a channeled wind turbine which funnels wind horizontally through a wind scoop and is directed towards turbine blades. The spinning of the turbine blades power a generator which produces electricity.

### BACKGROUND

Wind power is a free and inexhaustible (“renewable”) source of energy. Unlike fossil fuels such as coal and oil, which exist in a finite supply and which must be extracted from the earth at great environmental cost, wind turbines harness a boundless supply of kinetic energy in the form of wind. The wind turbines are located above-ground, typically in wind farms (or wind parks) which are a group of wind turbines in the same location used to produce electric power. A large wind farm may consist of several hundred individual wind turbines, and cover an extended area of hundreds of square miles.

Traditional windmills generally rely on a cut-in wind speed of at least 7 mph. The cut-in speed is the minimum wind speed at which the wind turbine will generate useable power, i.e. begin producing electricity. If the cut-in speed for the wind turbine can be reduced, the power output of the wind turbine can be increased.

Consequently, what is needed is a wind turbine which reduces the cut-in speed needed to power the turbine. In the present disclose a wind turbine, using the Venturi effect, is provided which funnels gathered wind into smaller channels causing the average speed of the wind flow to increase. As a result of the increased speed of the wind flow, the performance of the turbine is increased as the power output increases with the cube of the wind velocity.

### SUMMARY

The following presents a simplified summary of one or more implementations in order to provide a basic understanding of some implementations. This summary is not an extensive overview of all contemplated implementations, and is intended to neither identify key or critical elements of all implementations nor delineate the scope of any or all implementations. Its sole purpose is to present some concepts or examples of one or more implementations in a simplified form as a prelude to the more detailed description that is presented later.

According to one aspect, a horizontally channeled vertical axis turbine is provided. The horizontally channeled vertical axis turbine includes an ambient wind scoop structure, a horizontal laminar flow channel support structure and a self-supporting turbine disk structure. The ambient wind scoop structure includes an air scoop for gathering ambient wind and increasing the velocity of the ambient wind. The horizontal laminar flow channel support structure for receiving the gathered ambient wind includes an upper laminar air-flow channel having an upper inlet and an upper outlet, the upper inlet configured to receive a first portion of the gathered ambient wind from the air scoop; and a lower laminar air-flow channel having a lower inlet and a lower outlet, the lower inlet configured to receive a second portion of the gathered ambient wind from the air scoop. The self-supporting turbine disk structure includes a shaft bearing; a shaft having an upper end and an opposing lower end, the lower end attached to extending perpendicularly upward from the shaft bearing; a hub secured to the upper end of the shaft; a plurality of trusses having a first end and an opposing second end secured to, the first end connected to and extending horizontally outward from the hub; a plurality of turbine blades, a turbine blade located at the second end of each truss in the plurality of trusses; and a gearing assembly located on the shaft for securing a generator to the shaft.

According to one feature, a cross-sectional area of the upper laminar air-flow channel progressively decreases from the upper inlet and the upper outlet and a cross-sectional area the lower laminar air-flow channel progressively decreases from the lower inlet and the lower outlet.

According to another feature, the ambient wind scoop structure further comprises an adjustable front airfoil located on top of the ambient wind scoop for deflecting non-gathered ambient wind above air scoop creating a low-pressure area above the turbine blades.

According to yet another feature, the self-supporting channel structure further comprises an adjustable rear airfoil to reduce turbulence at the rear of the turbine which can interfere with a smooth exhaust above the turbine.

According to yet another feature, the self-supporting channel structure further comprises one or more upper roll-up throttle doors to regulate and control wind speed through the upper laminar air-flow channel to outlets at the front turbine blades at the front half of the wind turbine.

According to yet another feature, the self-supporting channel structure further comprises one or more lower roll-up throttle doors to regulate and throttle wind speed through the lower laminar air-flow channel to an outlet at the leeward or rear turbine blades at the rear half of the wind turbine.

According to yet another feature, the upper laminar air-flow channel comprises a plurality of individual upper channels; and wherein the lower laminar air-flow channel comprises a plurality of individual lower channels.

According to yet another feature, the plurality of turbine blades is formed in a circular configuration having a front half and a rear half where the rear half is located 180 degrees from the front half; wherein each individual upper channel in the plurality of upper channels directs the gathered ambient wind to a front half of the plurality of turbine blades; and wherein each individual lower channel in the plurality of lower channels directs the gathered ambient wind to a rear half of the plurality of turbine blades.

According to yet another feature, each turbine blade in the plurality of turbine blades have an equal amount of force exerted at the same time.

According to yet another feature, the self-supporting channel structure further comprises one or more first adjustable directional deflectors located at the upper outlet of the upper laminar air-flow channel below the plurality of turbine blades; and one or more second adjustable directional deflectors located at the lower outlet of the lower laminar air-flow channel below the plurality of turbine blades.

According to yet another feature, the self-supporting channel structure further comprises an expansion ring locate above the upper and lower laminar air-flow channels and the plurality of turbine blades.

According to yet another feature, the self-supporting channel structure further comprises an expansion ring support and exhaust deflector located within the expansion ring.

According to yet another feature, the ambient wind scoop structure further comprises a honeycomb airflow straightener located at an inlet to the air scoop.

According to yet another feature, the ambient wind scoop structure further comprises one or more air turbulence screens located between the honeycomb airflow straightener and the inlet to the air scoop.

According to one aspect, a horizontally channeled vertical axis turbine is provided. The horizontally channeled vertical axis turbine includes an ambient wind scoop structure, a horizontal laminar flow channel support structure and a self-supporting turbine disk structure. The ambient wind scoop structure includes an air scoop for gathering ambient wind and increasing the velocity of the ambient wind and an adjustable front airfoil located on top of the ambient wind scoop. The horizontal laminar flow channel support structure for receiving the gathered ambient wind comprises an upper laminar air-flow channel having an upper inlet and an upper outlet, the upper inlet configured to receive a first portion of the gathered ambient wind from the air scoop; and a lower laminar air-flow channel having a lower inlet and a lower outlet, the lower inlet configured to receive a second portion of the gathered ambient wind from the air scoop; wherein a cross-sectional area of the upper laminar air-flow channel progressively decreases from the upper inlet and the upper outlet; and wherein a cross-sectional area the lower laminar air-flow channel progressively decreases from the lower inlet and the lower outlet. The self-supporting turbine disk structure comprises a shaft bearing; a shaft having an upper end and an opposing lower end, the lower end attached to extending perpendicularly upward from the shaft bearing; a hub secured to the upper end of the shaft; a plurality of trusses having a first end and an opposing second end secured to, the first end connected to and extending horizontally outward from the hub; a plurality of turbine blades, a turbine blade located at the second end of each truss in the plurality of trusses.

According to one feature, the self-supporting channel structure further comprises one or more lower roll-up throttle doors to regulate and throttle wind speed through the lower laminar air-flow channel to an outlet at the leeward or rear turbine blades at the rear half of the wind turbine.

According to another feature, the upper laminar air-flow channel comprises a plurality of individual upper channels; and wherein the lower laminar air-flow channel comprises a plurality of individual lower channels.

According to another feature, the plurality of turbine blades is formed in a circular configuration having a front half and a rear half where the rear half is located 180 degrees from the front half; wherein each individual upper channel in the plurality of upper channels directs the gathered ambient wind to a front half of the plurality of turbine blades; and wherein each individual lower channel in the plurality of lower channels directs the gathered ambient wind to a rear half of the plurality of turbine blades.

According to yet another feature, each turbine blade in the plurality of turbine blades have an equal amount of force exerted at the same time.

According to yet another feature, the self-supporting channel structure further comprises one or more first adjustable directional deflectors located at the upper outlet of the upper laminar air-flow channel below the plurality of turbine blades; and one or more second adjustable directional deflectors located at the lower outlet of the lower laminar air-flow channel below the plurality of turbine blades.

### BRIEF DESCRIPTION OF THE DRAWINGS

Various features, nature, and advantages may become apparent from the detailed description set forth below when taken in conjunction with the drawings in which like reference characters identify correspondingly throughout.

FIG. 1 is a longitudinal cross-sectional elevation view of a horizontally channeled vertical axis turbine, according to one aspect.

FIG. 2 is a longitudinal cross-sectional elevation view of a horizontally channeled vertical axis turbine, according to one aspect.

FIG. 3 is a cross-sectional elevation close up view of a portion of a horizontal laminar air flow channel, according to one aspect.

FIG. 4 is a cross-sectional elevation view of a self-supporting turbine disk structure, according to one aspect.

FIG. 5 is a longitudinal cross-sectional elevation view of the horizontal channel support structure of FIG. 1.

FIG. 6 is a plan view of the upper horizontal channels of FIG. 1.

FIG. 7 is a plan view of the lower horizontal channels as viewed in FIG. 3 as well as from another angle in FIGS. 8 and 9.

FIG. 8 is a longitudinal elevation view of pitch control of blades at the start of rotation at +/−75 degrees, according to one aspect.

FIG. 9 is a longitudinal elevation view of pitch control of blades at +/−13 degrees, according to one aspect.

### DETAILED DESCRIPTION

In the following description, specific details are given to provide a thorough understanding of the embodiments. However, it will be understood by one of ordinary skill in the art that the embodiments may be practiced without these specific details. In other instances, well known methods, procedures, and/or components have not been described in detail so as not to unnecessarily obscure the embodiments.

### Overview

According to one aspect, a horizontally channeled vertical axis wind turbine for electrical power generation is provided. The wind turbine may collect ambient wind speed from between 0 ft. and +/−50 ft. above ground level, according to one example. The collected wind may be accelerated and concentrated within horizontal laminar flow channels within the turbine. The horizontal laminar flow channels may direct the accelerated and concentrated wind up and through to a smaller exhaust (i.e. the output or exhaust of the channels is smaller than the input to the channels) and to a series of turbine blades, located on a vertical axis turbine and shaft, which will provide power to an electrical generator or alternator located below the horizontally channeled vertical axis wind turbine.

According to one aspect, the horizontally channeled vertical axis wind turbine may comprise an ambient wind scoop structure, a horizontal laminar flow channel support structure and a self-supporting turbine disk structure. Each of these three main components may be self-supported and separated from each other by a minimum of three (3) inches or more in order to prevent the transfer of vibrations from the ambient air scoop structure to the horizontal channel support structure and then subsequently to the turbine support structure. By spacing the main components apart, excess wear on the main bearings may be eliminated extending the life of the bearings. Furthermore, the three (3) main sections may be insulated with rubber or other insulation, insulating the turbine disk structure, turbine, shaft, generator and other electrical components from damages caused by lightning strikes to other steel structures on the turbine, which are higher than the turbine disk. As discussed in more detail below, the turbine disk may comprise the hub, trusses, blades and hydraulic blade pitch piston of the turbine. By separating the three main sections, movement from wind pressure being transferred from the scoop section to the channel section and then to the wind turbine and support structure may be eliminated helping to protect the turbine and generator from vibrations, thus prolonging the life of the main support bearings. Additionally, this separation of the three main structures will also help protect the turbine and generator from lightning strikes, which could cause catastrophic damage to the generator and other electrical components.

According to one aspect, the ambient wind scoop structure may gather ambient wind and then concentrate and accelerate the wind into two (2) horizontal laminar air flow channels in the horizontal laminar flow channel support structure which is supported by the self-supporting turbine disk structure. As described in further detail below, the self-supporting turbine disk structure supports the vertical axis rotating turbine, blades, trusses, hub and shaft, down to the main ground bearing and through a 90 degree gearing system to the electrical generator or alternator at ground level. The self-supporting turbine disk structure also reduces or eliminates the need for a supporting structure to be located above the turbine disk that would interfere with the free flow of wind that is needed for the wind to exit the exhaust from the channels located above the blades and the expansion rings of the horizontally channeled vertical axis wind turbine.

According to one aspect, the ambient wind scoop structure includes a large wind scoop which gathers the ambient wind. Once captured, the ambient wind may then be concentrated and accelerated into two (2) separate groups of horizontal laminar air flow channels, one upper channel and one lower channel, each having +/−8 separate channels. That is, the captured wind may be strengthened and directed at the opening of the wind scoop to upper and lower laminar flow channels where the wind velocity is increased. By decreasing the size of each of the +/−8 outlets or exhausts of the channels until the entire cross-sectional area of all the outlets is 4 to 5 times smaller than the cross-sectional area of the inlet scoop and the opening of the channels, the ambient wind velocity may be increased by a factor of the cube of four (4) or five (5).

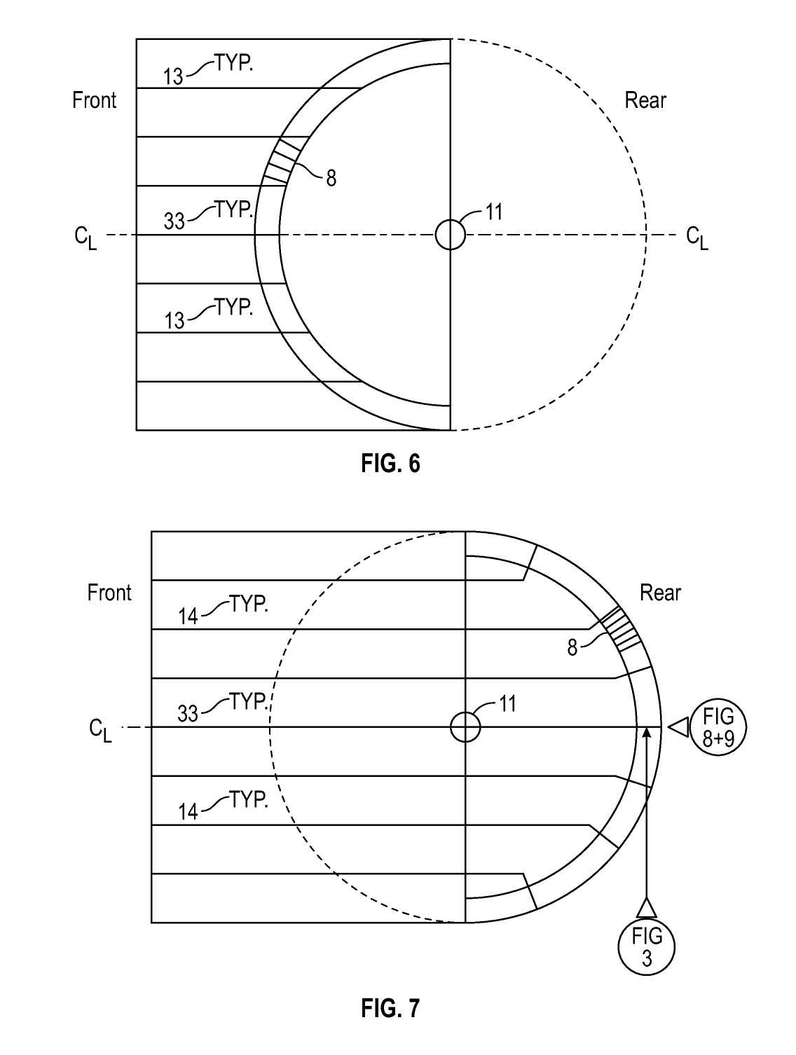

According to one aspect, the horizontal laminar air flow channel support structure supports the upper and lower laminar flow channels which accelerate the wind within the channels and directs it to the end of the channels and to outlets of the turbine where the accelerated wind is concentrated and directed toward turbine blades above. Both the upper and lower laminar flow channels may each comprise 30/−8 individual channels which correspond to different cords, i.e. a section of the arc, on the turbine disk. Each individual channel in both the upper and lower laminar flow channels direct the collected wind to a specific section on the turbine blades. (FIGS. 6-7) That is, the upper channels (30/−8) may direct the accelerated wind velocity up and to the front (windward) half (180 degrees) of the wind turbine blades while the lower channels (30/−8) may direct the accelerated wind velocity up and to the rear (leeward) half (180 degrees) of the turbine blades. Thus, all the turbine blades may have the same amount of force exerted on all the blades at the same time maintaining approximately equal force as evenly as possible on the entire turbine and blades at the same time. Although 8 individual channels are described, this is by way of example only and each channel may have more than 8 individual channels or less than 8 individual channels.

According to one aspect, the increase in velocity of the ambient wind may be created by progressively decreasing the cross-sectional area of the channels, from the scoop to the outlets at the end of the channels. This accelerated wind may then be directed up 90 degrees and focused on to the horizontal wind turbine blades located just above the accelerated wind outlet (i.e. the a smaller outlet below the turbine blades) causing the turbine disk to rotate. The velocity of the accelerated wind may be equal to the cube of the increase in the velocity of the wind that enters the scoop and the channels as is known in the art by the Venturi Effect. Additionally, as is known art, ambient wind cannot be compressed, but it can be accelerated through the channels by capturing the ambient wind in the large area scoop and concentrating it and directing it to and through the horizontal channels. This accelerated wind in the channels causes a large increase in force, which is directed to the turbine blades. Because power to the turbine blades is proportional to the cube of the wind speed increase, any large increase in speed within the horizontal channels will cube the force exerted to the turbine blades. Therefore, the optimum ratio of wind inlet area to output area may be between 2.5:1 and 5:1. This ratio may be designed and maintained throughout the horizontally channeled vertical axis wind turbine in order to produce the required force and horsepower transmitted from the blades to the shaft to produce large amounts of electricity. This large force concentrated at the turbine blades may be transferred through the turbine disk to the vertical axis shaft and down the shaft to the generator or alternation below, through a 90 degree gearing assembly, where it is converted to electrical energy.

According to one aspect, as a result of the very large velocity increase at the outlet of the channels, a large increase of force may be directed to the blades and subsequently transferred through the trusses and the hub, down to the shaft and the generator below, at ground level. The pitch on the blades, such as airfoil shaped blades, may be hydraulically controlled and can change the pitch and angle of attack of all of the blades equally from star-up at +/−75 degrees to +/−13 degrees at full turbine RPM. After the force on the blades has been exerted, the wind stream may exit the blades and enter an expansion ring (expansion chamber) where it may expand and slow down before it is removed by the negative pressure above wind turbine disk. This negative pressure may be increased by an airfoil located above the wind scoop, which directs the ambient airstream above the scoop up and away from the turbine blades, thus limiting the backpressure of the exhaust as it leaves the expansion ring as is known in the art based on the Bernoulli principle. As the accelerated wind within the horizontal channels is concentrated and directed to the turbine blades, a large force may be created at the blades causing the turbine to turn. This large force may be reduced by backpressure caused by interruption and enthalpy with the blades. This backpressure or enthalpy may be reduced by the installation of the expansion ring that will allow the exhaust turbulence, after the blades, to expand and slow within the expansion ring before it leaves the expansion ring and is exhausted by the negative pressure and relative wind stream created above the turbine, thus increasing the force on the blades and increasing the horsepower at the shaft.

According to one aspect, a large airfoil may be installed atop the ambient wind scoop causing the low-pressure area above the turbine disk and exhausts to increase. As a result, the backpressure above the expansion ring, exhausts and turbine disk may be reduced allowing the exhausted air to enter the ambient wind stream above the turbine with less turbulence increasing horsepower to the shaft. Additionally, a trailing edge airfoil may be placed at the rear of the turbine to reduce rear turbulence, which also could disrupt the ambient wind stream.

According to one aspect, the large rotating turbine disk (50 ft. to 160 ft.) of the turbine which has a plurality of blades, up to 300 for example, may have a large amount of inertia once it begins rotating. This large inertia provides the wind turbine of the present disclosure with an advantage over existing 3 blade wind turbines by creating a smoother electrical output signal. Additionally, this large inertia may create a much smoother electrical output with much less stress being placed upon the main bearings, which translates into longer life and less maintenance costs.

According to one aspect, one or more doors may be installed at the entrance of the horizontal channels to regulate the amount of wind and wind speed within the horizontal channels and as a result to the turbine blades. These doors may be required in high wind conditions to protect the turbine from excess speed that could damage the blades or other components. The doors may also be used to regulate the wind speed within the channels to maintain the proper speed of the turbine. The doors can be closed and the turbine disk locked, for safety purposes, when servicing the turbine or for routine maintenance. Also, the doors may be configured to automatically close upon loss of grid power should the grid power be shut down for any reason. The doors may be opened again when grid power is returned, after a short delay to insure that the grid has been stabilized, in order to restart supplying power to the grid. The doors may be opened and closed using a computerized hydraulic pneumatic system, or any other system known in the art.

According to one aspect, the horizontally channeled vertical axis wind turbine of the present disclosure may be installed side by side with other existing turbines of approximately the same size and type creating a “wall of turbines” that can capture all the available wind from between 0 to +/−50 feet. When the horizontally channeled vertical axis wind turbines are installed side by side, the ambient wind from between 0 to 50 feet cannot go around the “wall of turbines” but must go through or over the top of the “wall of turbines”, thus allowing all the turbines to operate more efficiently and the output of the group of turbines to be more than the sum of each turbine. The added benefit of installing the turbines next to each other is that the wind capture is increased increasing the negative pressure on top of all the turbines, thus increasing performance. According to one example, with this side by side arrangement as many as 60, 100 ft. diameter turbines can be installed on 100 square acres, depending on the length of the set-back between rows of turbines. Alternatively, the horizontally channeled vertical axis wind turbine described herein may be stand alone.

According to one aspect, the blades of the horizontally channeled vertical axis turbine may be configured to rotate either clockwise or counterclockwise.

### Horizontally Channeled Vertical Axis Turbine

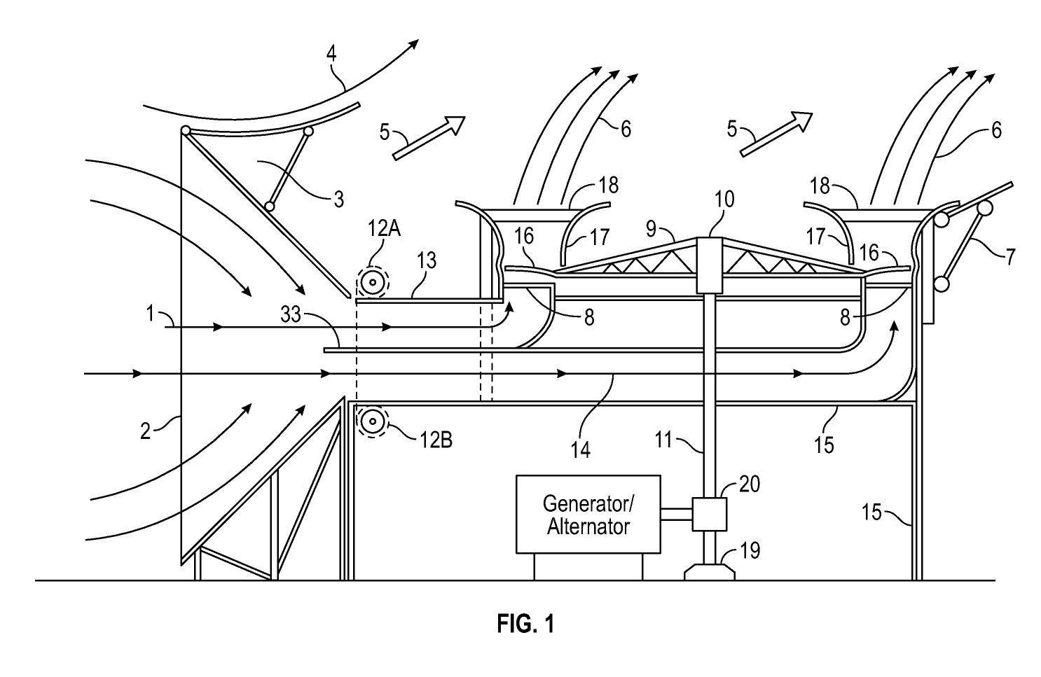

FIG. 1 is a longitudinal cross-sectional elevation view of a horizontally channeled vertical axis turbine, according to one aspect. The turbine may transfer the horizontal ambient wind stream and speed up the wind stream as it is directed up to the horizontally channeled vertical axis wind turbine to create large amounts of electricity.

As described above, the horizontally channeled vertical axis wind turbine of the present disclosure may be comprised of three main structures or components: an ambient wind scoop structure, a horizontal laminar flow channel support structure and a self-supporting turbine disk structure. Each of these three main structures may be self-supported and separated from each other by three (3) inches or more to prevent transfer of vibrations to the structure supporting the main turbine and blades. Furthermore, as described in more detail below, the ambient wind scoop structure may be insulated from the horizontal laminar flow channel support structure and the self-supporting turbine disk structure to prevent damage to the generator and other electrical systems from lightning strikes.

### Ambient Wind Scoop Structure

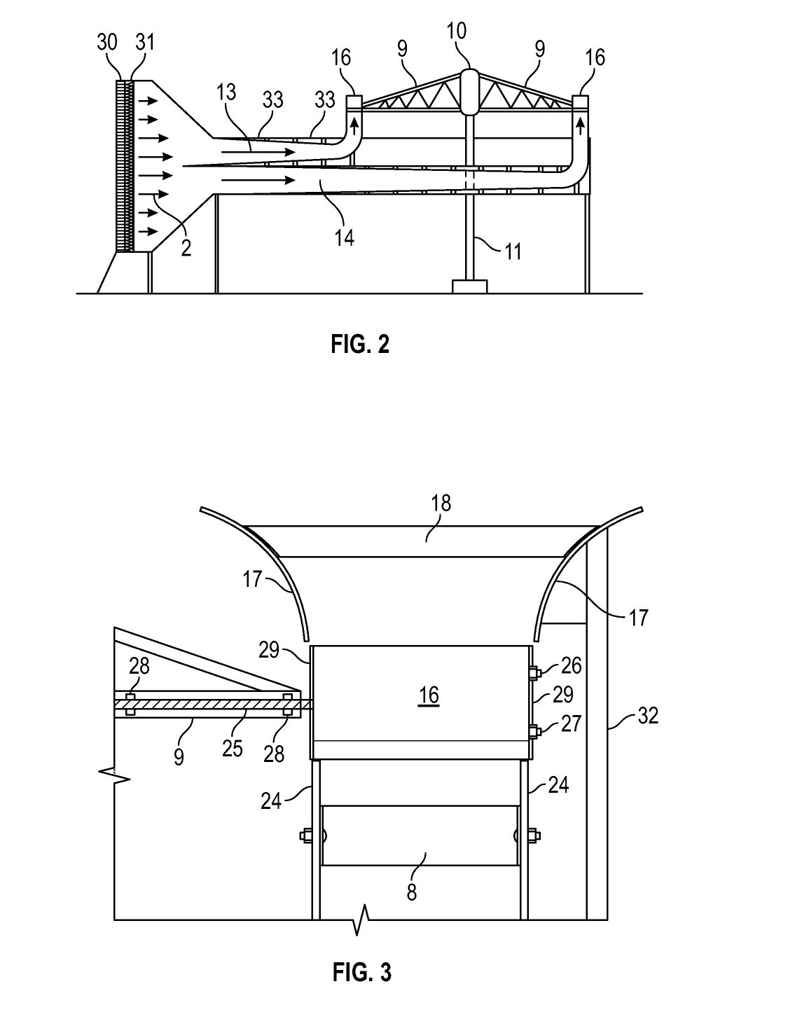

The ambient wind scoop structure may include an ambient wind scoop 2 for gathering ambient wind 1. As the ambient wind 1 enters the ambient wind scoop 2, the ambient wind scoop 2 may increase the wind velocity of the ambient wind 1 and directs it into a first or upper laminar air-flow channel 13 and a second or lower laminar air-flow channel 14. Although the cross-sectional areas of the upper laminar air-flow channel 13 and the lower laminar air-flow channel 14 are shown as constant along the longitudinal lengths of the channels in FIG. 1, each of the channels 13, 14 may progressively decreases in cross-sectional area towards the outlets of the channels as shown in FIG. 2. This decrease in the cross-sectional area of the channels causes the wind velocity and force on wind turbine blades 16 within the horizontally channeled vertical axis wind turbine to increase. As the power input to the turbine blades 16 is proportional to the cube of the wind velocity increase, the size of the ambient wind scoop 2, the amount of wind collected and directed through the channels to the outlets and subsequently to the turbine blades 16 may cause a minimum size ratio of between 2.5:1 to 5:1 to be maintained from the input at the wind scoop to the outlet output (Exhaust) to the blades 16.

The ambient wind scoop structure may further include an adjustable front airfoil 3 located on top of the ambient wind scoop for deflecting any ambient wind 4 above the wind turbine to create a low-pressure area above the turbine blades 16. As a result, backpressure and discharge turbulences at the blade exhaust area may be reduced which in turn allows for more force to be added to the blades. The front airfoil 3 may be hinged to the wind scoop 2 and may be adjustable according to the speed of the ambient wind 4 above the wind turbine to regulate the amount of negative pressure above the turbine blade exhaust area 6 as is well known in the art according to the Bernoulli Principle.

A negative (low) pressure area 5, located above the turbine blade exhausts 6, may reduce back pressure and turbulence at the turbine blades exhausts 6, which can cause losses in output power to the generator. This allows the system to “breath” by allowing the exhaust stream to enter the air stream above the turbine more smoothly and with less turbulence.

### Horizontal Laminar Flow Channel Support Structure

The horizontal laminar flow channel support structure may include the upper laminar air-flow channel 13 and the lower laminar air-flow channel 14 which, as described above and shown in FIG. 2, progressively decrease in cross-sectional area towards the outlets or ends of the channels. The decrease in the cross-sectional area causes the wind velocity and force on the wind turbine blades 16 to increase. The upper and lower laminar flow channels accelerate the wind within the channels and direct it to the outlets or end of the channels where the accelerated wind is concentrated and directed toward turbine blades above. Both the upper and lower laminar flow channels may each comprise 30/−8 individual channels which correspond to different cords, i.e. a section of the arc on the turbine disk. Each individual channel in both the upper and lower laminar flow channels may direct the collected wind to a specific section on the turbine blades 16. (See FIGS. 6-7) That is, the upper channels (30/−8) may direct the accelerated wind velocity up and to the front (windward) half (180 degrees) of the wind turbine blades while the lower channels (30/−8) may direct the accelerated wind velocity up and to the rear (leeward) half (180 degrees) of the turbine blades. Thus, all the turbine blades may have the same amount of force exerted on all the blades at the same time.

The upper laminar air-flow channels 13 (30/−8) may direct, concentrate, conduct and accelerate the ambient wind speed coming from the ambient wind scoop 2 and direct a portion of the ambient wind to the front half of the exhaust outlets for the windward or front half of the wind turbine blades 16 in the front on half of the turbine. This acceleration causes large force increases at the turbine blades. Because the power increase on the turbine blades is proportional to the cube of the wind speed increase, large forces will be directed to the blades as is known in the art with the Venturi effect. This is achieved by capturing a large area of ambient wind, from the large air scoop 2 at the front of the channels 13, 14, speeding it up inside the laminar flow channels and concentrating that force, through a smaller output, to the turbine blades 16. The optimum ratio of wind inlet area to output area may be from between 2.5:1 to 5:1. This ratio may be designed and maintained throughout this horizontally channeled vertical axis wind turbine in order to produce the required velocity, pressure and horsepower, at the blades and to the shaft, for producing large amounts of electricity. Furthermore, a smooth laminar flow, free of obstructions, of air through the channels may be obtained.

The upper and lower horizontal channels 13, 14 may extend toward the front air scoop 2 to increase and smooth-out the laminar flow of the sped-up ambient wind stream 1 from the scoop 2 reducing turbulences and eddies within the channels 13, 14 that may cause losses in the force exerted at the turbine blades 16. Additionally, it may increase the force on the turbine blades 16 which may translates into more horsepower delivered to the generator and more electricity being produced. The further the channels 13, 14 are extended away from the front ambient air scoop 2, but not so far as to increase parasitic drag, the laminar flow within the channels may be increased delivering a smoother, less turbulent air flow to the turbine blades 16. Smooth 90 degree turns up to the discharge to the blades may be utilized.

The lower horizontal channels 14 (30/−8) may direct, concentrate, conduct and accelerate the ambient wind speed coming from the front wind scoop 2 and directs it to the rear exhaust at the wind turbine blades 16 in the rear half of the turbine. As described above, by progressively decreasing the cross-sectional area away from the scoop and towards the outlet may increase the wind speed within the channels 13, 14 and at their respective outlets. The lower horizontal channel 14 may work the same as the upper channel 13 and perform the same function as the upper channel but supplies the accelerated wind force to the rear half of the turbine exhaust and blades at the rear half of the turbine.

According to one aspect, the horizontal laminar flow channel support structure may further include upper roll-up throttle doors 12A to the upper laminar flow channel 13 for regulating and controlling the wind speed through the upper channels to the windward or front outlets and to the front half or the blades (90 degrees). The upper roll-up throttle doors 12A may be installed to control the amount of airflow within the channels and when ambient wind speed may be excessive which may cause damage to the turbine or blades. The doors 12A may also be closed when the wind turbine is to be shut down for maintenance or repairs or when the grid is down. A breaking system and lock may be used for safety when the turbine is shut down. These doors 12A may throttle wind speed in the channels and control pressure to the turbine blades 16. This control can be adjusted to fit into any parameter of any ambient wind conditions, speed, area or local. The doors 12A may roll down to close and up to open and may be linked with lower doors 12B, described below, to maintain equal forces applied to both the front and rear exhausts of the channels 13, 14 and to all blades 16 equally.

According to one aspect, the horizontal laminar flow channel support structure may further include lower roll-up throttle doors 12B to the lower laminar low channels 14 to regulate and throttle wind speed through the lower channels 14 to the outlet at the leeward or rear turbine blades at the rear half of the wind turbine. The doors 12B may work the same as the upper roll-up doors 12A but may be installed in the opposite direction. These doors 12B may roll down to open and up to close and may be linked with the upper doors 12A to maintain equal forces applied to both the front and rear exhausts and to all blades 16 equally.

Self-Supporting Turbine Disk structure

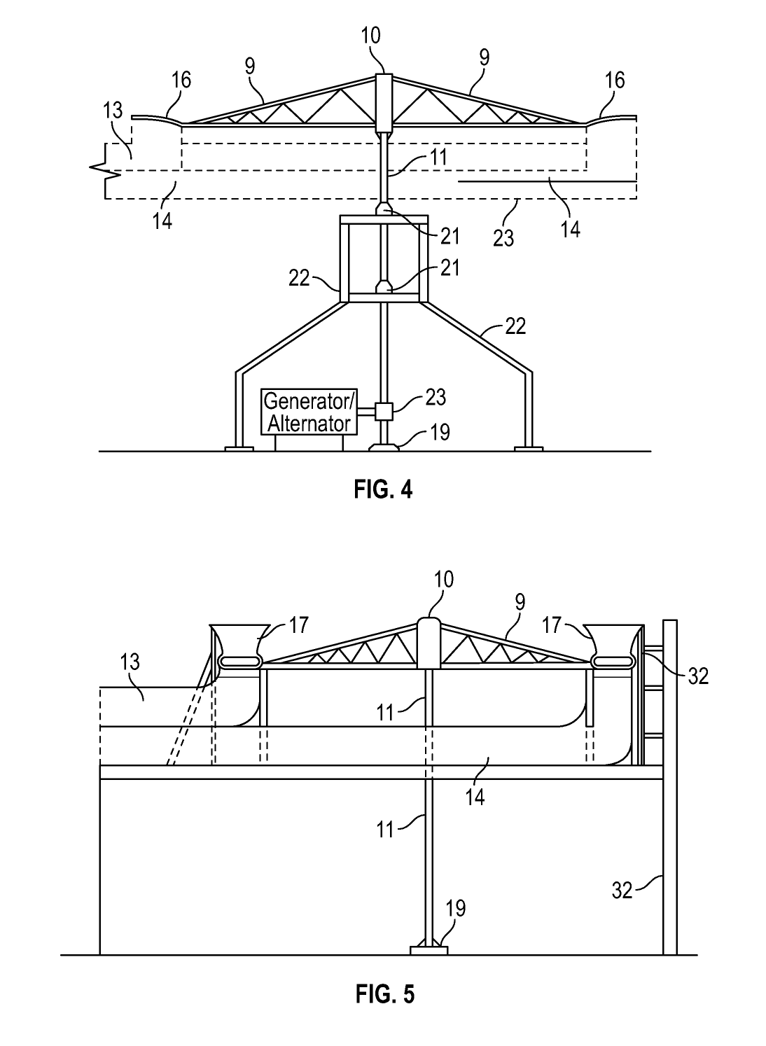

The self-supporting turbine disk structure is separated by a minimum of three 3 from the self-supporting channel structure. The self-supporting turbine disk structure may include a main rotor shaft 11 having an upper end and an opposing lower end. The main rotor shaft 11 may be sized to be capable of handling the amount of torque produced by the main turbine disk structure to a generator located below. Two (2) upper collar/thrust bearings 21 (See FIG. 4) may be located on the upper support structure to support the shaft 11 from upwards and lateral movement. The shaft 11 can be installed with a 90 degree gearing assembly 20 (which transmits energy from a vertical twisting to a horizontal twisting), with optional reduction gearing, to adapt to horizontal drive generators, allowing either vertical or horizontal drive generators and reduction gearing to be installed below the wind turbine, at ground level and for easy access for installation and repairs. The shaft 11 may be hollow to allow for hydraulic lines to travel up inside the shaft to a hydraulic blade pitch piston located within a hub (described below).

The main rotor shaft 11 may be attached to and extend generally perpendicularly upward from a main shaft bearing 19 at the bottom shaft end. This main shaft bearing 19 may be installed on a level structural steel support structure installed on a concrete foundation, for example. The gearing assembly 20, such as a 90 degree gearing assembly, may be located on or secured to the main rotor shaft 11 connecting a generator or alternator to the main rotor shaft 11. The gearing assembly 20 may include a reduction gear assembly to accommodate any horizontally connected generators or alternators.

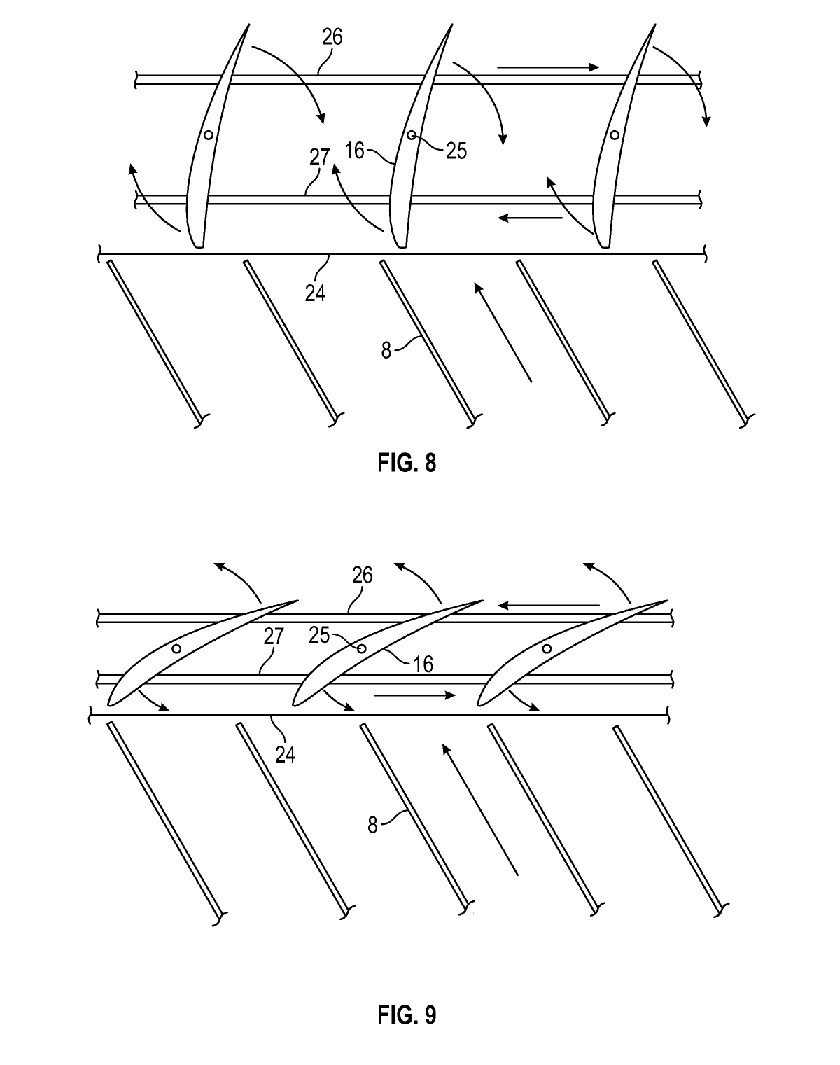

The self-supporting turbine disk structure may further include a hub 10 attached to an upper end of the main rotor shaft 11 and designed to carry and connect one or more trusses (or truss members) 9 to the main rotor shaft 11. The hub 10 may include a hydraulic blade pitch piston which may transfer hydraulic pressure exerted on it to alular movement and thus turn pitch control rods 25, extending outward from the hub 10, along the bottom cord of the trusses 9 to the blades 16. There may be one pitch control rod 25 for each of the trusses 9, which may rotate the center blade, about its axis on a center bearing, for each group of five (5) blades per section of a turbine blade array (See FIGS. 8 and 9). As the center blade changes pitch, either up or down, the other 4 blades (2 on each side) may also change pitch by being connected through connecting rods 26 and 27 attached close to the top and bottom of each blade and connected to the center blade through the pitch control rods 25 and to the hub 10 allowing all the blades will change pitch at the same time. According to one aspect, the hub 10, trusses 9, blades 16 and hydraulic blade pitch piston (located within the hub) may form a turbine disk.

According to one aspect, on a 50 ft. diameter wind turbine, there may be approximately 6-20 lightweight trusses extending out from the main support hub 10, however this is by way of example only and there may be less than 6 lightweight trusses or more than 20 lightweight trusses. Within the hub 10 there may be a hydraulic piston that will go up or down through hydraulic pressure. The hydraulic piston may be connected to 20 rack and pinion gear assemblies (or as many assemblies as there are trusses) as is known in the art. As the rack gears are moved up and down by the hydraulic piston they may rotate as many pinion gears. The pinion gears may be connected to an axle and bearing through to the outside of the hub 10. A female to male spline connection, along with universal couplings, may be mounted on the outside of the hub 10 to connect the blade pitch control rods 25. As the hydraulic piston in the hub 10 moves up and down it may transfer the up and down motion to twist the rods 25 clockwise or counterclockwise thus changing the pitch on all the blades equally. The control of the hydraulics, and thus the pitch of the blades 16, may utilize many inputs, including but not limited to, ambient wind speed, the velocity of the accelerated wind at the outlets and the RPM of the turbine disk. The hydraulics may rotate and change the pitch of the blades constantly to maintain the best possible angle of attack, on the blades, in order to produce the most horsepower output for any given wind speed or conditions.

In one configuration, the trusses 9 may have a generally tapered or arched configuration and extend outwardly from the hub 10 at one end and be configured to carry rotor blades 16 extending outwardly from a second end of the truss members 9. The trusses 9 may be light weight so that they can carry the weight of the rotor blades 16 over the distance between the hub 10 and the rotor blades 16. As a result, the overall weight of the turbine disk may be lower which in turn reduces wind drag losses as the turbine turns. According to one example, the turbine disks may have a diameter between 50 ft. to 160 ft.

The self-supporting channel structure may further include an adjustable rear airfoil 7 near the output of the lower horizontal laminar air flow channel 14 for directing turbine blade exhaust into the prevailing wind stream and limits turbulences and vortices behind the turbine that can disrupt turbine exhausts and cause unwanted backpressure and other turbulence losses.

According to one aspect, an expansion ring 17 may be located above the turbine blades 16. As the accelerated wind stream within the upper and lower horizontal channels 13, 14 is concentrated and directed to the turbine blades 16, the turbine blades may begin to rotate. This large force of accelerated wind could be reduced by backpressure caused by interruption and enthalpy with the blades. By installing the expansion ring (or expansion chamber) above the blades 16, the exhaust turbulences and enthalpy will be reduced by slowing down and expanding the exhaust within the ring 17, allowing it to be easily removed by the negative pressure and the relative wind stream above the turbine created by the front airfoil 3. As a result, the backpressure at the blades 16 may be lowered and the horsepower at the shaft 11 increased.

According to one aspect, an expansion ring support and exhaust deflector 18 may be located inside the expansion ring 17. The expansion ring support and exhaust deflector 18 may deflect and direct the exhaust airstream towards the back of the turbine so that it can inter the rearward flowing airstream above the turbine lowering the turbulence and backpressure from the blades 16 and the expansion ring 17.

FIG. 2 is a longitudinal cross-sectional elevation view of a horizontally channeled vertical axis turbine, according to one aspect. The horizontally channeled vertical axis turbine of FIG. 2 includes many of the same parts as the horizontally channeled vertical axis turbine of FIG. 1 and the same reference numbers are utilized to refer to the same parts.

In horizontally channeled vertical axis turbine of FIG. 2, the upper and lower horizontal laminar flow channels may decrease in cross sectional area as they conduct the increased ambient wind velocity and direct it up to the outlets that have a smaller cross sectional area than the inlets. The cross sectional area of the channels 13, 14 is reduced as the channels 13, 14 extend away from the ambient wind scoop 2 and towards the outlets thereby increasing the velocity of the ambient wind and directing this accelerated wind up and to the blades 16 increasing the pressure exerted on the blades. The upper and lower channels 13, 14 may be supported strongly within the structure where they will receive much vibration from the wind speeding up within them.

As with the horizontally channeled vertical axis turbine of FIG. 1, the horizontally channeled vertical axis turbine of FIG. 2 depicts the main shaft 11 main shaft 10, which is separated by a minimum of three inches and insulated from the channel support structure, connecting the turbine disk to the generator or alternator located below the turbine disk structure. Light weight trusses 9 may be utilized to support the turbine blades 16 and the blade pitch control rods 25 that change the pitch of the blades 16. Furthermore, the main support hub 10 may connect the trusses 9 to the main shaft 11 and includes the hydraulic blade pitch control piston, which rotates the blade pitch control rods 25 to change the pitch at the blades all of which is separated and insulated from the rest of the structure.

The horizontally channeled vertical axis turbine of FIG. 2 may further include a honeycomb airflow straightener 30 and air turbulence screens 31. The straightener 30 and screens 31 may located at the front of the ambient air scoop 2 and utilized to straighten and direct the ambient wind entering into the air scoop 2 and to lower the turbulence within the scoop 2 so that it can be delivered to the upper and lower laminar flow channels 13, 14 with most of the turbulence removed so that the velocity can be increased and directed more efficiently. As shown, the wind may enter through the honeycomb airflow straightener 30 and then into the air turbulence screens 31.

Turning to FIG. 3, a cross-sectional elevation close up view of a portion of a horizontal laminar air flow channel outlet is shown. As shown in FIG. 3, the horizontally channeled vertical axis turbine may include adjustable directional deflectors 8 located at the outlet and below the turbine blades 16 in respective laminar flow channel outlets 24 in each of the upper and lower horizontal laminar air flow channels 13, 14. The adjustable directional deflectors 8 may redirect high velocity wind stream toward the turbine blades 16 at the most optimum angle and force delivered to the turbine blades 16 and shaft 11. Each laminar flow channel outlet 24 may accelerate and concentrate velocity of the wind stream up and to the rotating blades 16 of the turbine. This accelerated wind stream may be directed at an angle towards the blades 16 by the adjustable directional deflectors 8 below, so that the wind stream is directed to the blades 16 at the optimum angle and force to the blades 16.

As described previously, the trusses 9, connected to the hub 10 are designed to carry the weight of the turbine blades 16 over the distance between the hub 10 and the turbine blades 16. Additionally, the trusses 9 may also support the blade pitch control rods 25 which may change the pitch of all the blades at the same time. As a result of this design, drag may be reduced and the overall weight of the turbine disk may be lowered. In one configuration, the design described herein may be utilized with turbines having turbine disks with a diameter from between 50 feet and 160 feet, according to one example. The blade pitch control rods 25 may be located on the bottom cord of the trusses 9 and are rotated at the hub 10 by the hydraulic pitch angle piston, located within the hub 10. The blade pitch control rods 25 may be connected to the blades 16 and as the rods 25 rotate they change the pitch and angle of attack of the blades 16 at the ends of the trusses 9.

The main rotor turbine blades 16 may be shaped to receive optimum wind force and transfer that force through the turbine trusses 9 to the hub 10 and down the shaft and to the generator. The blades 16 may be aerodynamically shaped airfoils comparable to NACA 6409 airfoils which are designed specifically for low wind speed characteristics. The airfoil blades 16 may be mounted at the center axis of the blades to provide for rotation and support on shaft bearings. The airfoil blades 16 may be connected together so that by rotation of the shaft of one blade, all the others that are connected to that blade may rotate equally. The blades may rotate and change pitch from +/−75 degrees at start-up and continue to decrease in pitch and angle of attack to +/−13 degrees as the velocity of the wind within the horizontal channels increases and the speed of the turbine disk increases up to maximum RPM for the most optimum use of the accelerated wind stream exiting the channel outlet. That is, to extract the most force for any given ambient wind velocity.

According to one aspect, a hydraulic control system may be installed to change the pitch and angle of attack of the blades 16 with inputs from the velocity of the wind within the channels 13 and 14, the speed of the turbine rotation and any other input that may be required. The pitch and angle of attack of the blades 16 may be controlled by hydraulic pressure which may move the blade pitch control piston up or down within the hub 10 and transfer that movement to the pitch control rods 25, one each, supported by the bottom of each turbine truss 9 by bearings and supports. The rotation of the pitch control rods 25 may be connected to the center of five turbine blades, which will be coupled together so that when the center blade changes pitch the other blades may also change pitch equally. There may be multiple adjustable directional wind deflector blades located within the exhaust outlet, below the blades, to direct the high-speed wind at the outlet towards the blades at the best possible angle.

According to one aspect, upper and lower blade connector push rods may be connected to the upper and lower portions of the airfoil blades 16 so that when the center blade is rotated about its axis and center rod bearings 28, it may cause all the blades that are connected to the center blade to change pitch equally. The blade pitch control rod bearings and supports 28 may be installed at different locations along the bottom cord of the trusses 9 to support the blade control rods 25 and allow the rods 25 to turn easily to control the pitch and angle of attack of the main turbine blades 16. According to one aspect, blade end airstream deflectors (fences) 29 may be utilized to guide and channel the airstream over the top and the bottom of the airfoil blades 16 and prevent the airstream from dispersing around the blades 16 thus concentrating the airstream on the blades 16 to optimize the force exerted on the blades 16 and thereby lowering the losses at the blades 16.

The output of the horizontal laminar air flow channels 13, 14 may include an exhaust expansion ring (chamber) 17 located above all the turbine blades 16. All exhaust goes up into the ring equally. As the accelerated wind stream within the horizontal channels is concentrated and directed to the turbine blades 16, the turbine blades 16 begin to rotate. This large force of accelerated wind could be reduced by backpressure caused by enthalpy and interruption with the blades 16. By installing the expansion ring (expansion chamber) 17 above the blade exhaust, the exhaust turbulences and enthalpy may be reduced by slowing down and expanding the exhaust within the ring 17, allowing it to be easily removed by the negative pressure and the relative wind stream above the turbine created by the front airfoil 3. As result, the backpressure at the blades 16 may be lowered and the horsepower at the shaft increased.

The output exhausts of the horizontal laminar air flow channels 13, 14 may further include an expansion ring support and exhaust deflector 18 located above the blades 16 within the exhaust expansion ring (chamber) 17. The expansion ring support and exhaust deflector 18 may support the inside portion of the expansion ring 17 and also deflect and direct the exhaust airstream towards the back of the turbine so that it can enter the rearward flowing airstream above the turbine, thus lowering the turbulence and backpressure from the blades 16 and the expansion ring 17.

FIG. 4 is a cross-sectional elevation view of a self-supporting turbine disk structure, according to one aspect. The self-supporting turbine disk structure of FIG. 4 may be designed to support the turbine disk structures described in the present disclosure including the shaft 11, hub 10, trusses 9, bearings 19 and turbine blades 16 from below the turbine disk and below the upper and lower horizontal channels 13, 14, independent of, and insulated from, the surrounding structures.

Similar to the structure of FIGS. 1 and 2, the self-supporting turbine disk structure of FIG. 4 may be separated by three (3) inches or more and insulated between the three (3) separate structures. As described above, this separation may prevent the transfer of vibration from the front ambient air scoop structure to the horizontal channel structure and then to turbine support structure itself. This design may also insulate and limit damages to the generator and electrical components caused by lightning strikes to the other two metal structures, which may be above the turbine disk. This design, of supporting the upper turbine disk structure and turbine disk from below the turbine disk and below the lower horizontal channels may eliminate the need for an upper support structure to be built above the turbine disk to hold the top bearing of the turbine disk.

According to one aspect, there may be no superstructure built above the turbine blades as it would interfere with the airstream above the turbine exhaust. The elimination of an upper support structure above the turbine disk may lower disruptions and other turbulences, within the low-pressure area above the turbine disk. As a result, the power to the turbine blades may be increased by increasing the back pressure at the blade exhausts and allow for a much smoother transfer of the channeled exhaust to be carried away by the ambient air stream above the wind turbine disk structure.

According to one aspect, the structure of FIG. 4 may also be designed and constructed with the top bearing structure and thrust bearings located below the bottom channel with the shaft extending down between the lower horizontal channels and the main support bearing located at ground level which will carry all the weight of the turbine blades, trusses, hub and main shaft. Additionally, this design would also eliminate any superstructure above the turbine disk.

As shown in FIG. 4, the main turbine support structure may be designed to separately support and hold steady the main turbine, blades 16, trusses 9, hub 10 and shaft 11 which may be separate from the other two structures and not supported by either structures to prevent vibration and protect it from lightning strikes. The wide stance of the structure 22 may allow substantial room to install a generator or multiple generators, the inverter and related switch gear and other reduction gearing as needed with access to ground level equipment for installations and repairs. The dotted lines 23 represent superimposed horizontal laminar air flow channels 13, 14 (in relation to the turbine support structure) which are part of a separate structure and not attached to the wind turbine support structure. As described before, these structures may be separated and supported independently to prevent vibration from being transferred to the turbine support structure from the other two structures as well as to limit damage from lightning strikes that could damage the generator and other electrical parts.

The main shaft 11 of the self-supporting turbine disk structure may be sized to be capable of handling the amount of weight and torque forces produced by the main turbine disk structure to the ground where the main bearing carries all the weight of the turbine disk structure. The main shaft 11 may be attached to and extend generally perpendicularly upward from the main shaft bearing 19 at the bottom shaft end. This main shaft bearing 19 may be installed on a level structural steel support structure installed on a concrete foundation, for example. The gearing assembly 20, such as a 90 degree gearing assembly 20, may be located on or secured to the main rotor shaft 11 connecting a generator or alternator to the main rotor shaft 11. The gearing assembly 20 may include a reduction gear assembly to accommodate any horizontally connected generators or alternators. That is, vertical axis turbine shaft can be adapted through a 90 degree gear drive below to connect to horizontal drive generators, allowing either vertical or horizontal drive generators to be installed below the wind turbine at ground level.

According to one aspect, top supporting thrust bearings 21 may be connected to the upper part of the shaft 11 for maintaining the shaft 11 in alignment and preventing it from moving laterally and/or vertically up or down. A middle thrust bearing 21 may be connected to the middle of the shaft 11 for maintaining the shaft 11 in alignment and to keep the blades from moving laterally and up and down.

FIG. 5 is a longitudinal cross-sectional elevation view of the horizontal channel support structure of FIG. 1 as described previously. The support structure includes a structural steel structure 32 that can support all the components, both vertically and laterally, of the horizontally channeled section. The components include, but are not limited to, the upper and lower horizontal laminar flow channels 13, 14, the expansion ring 17, and the upper and lower throttle doors 12A and 12B and the rear air foil 7.

FIG. 6 is a plan view of the upper horizontal channel of FIG. 1. As shown, the hub 10 and shaft 11 are located in the center and connect to the generator and center of the turbine as described above. Adjustable directional deflectors 8 may be located in each section or cord of the arc at the outlets. Eight individual channels are shown in the upper horizontal channel 13 which delivers equal amounts of accelerated ambient wind to the eight front exhausts to the turbine blades through the adjustable directional deflectors 8. Although eight individual channels are shown, this is by way of example only and there may be more than eight individual channels or less than eight individual channels. The deflectors may be adjustable to allow for optimum directional flow of the airstream for any particular wind conditions encountered in different locals and wind farms.

Also shown in FIG. 6 is an extension of the horizontal laminar air flow channels 33. The upper and lower horizontal channels 13, 14 may be extended toward the front air scoop 2 to increase and smooth-out the laminar flow of the accelerated ambient air stream reducing turbulences and eddies that may cause losses in the force exerted at the turbine blades 16. This extension may increase the velocity and force on the turbine blades 16 which may translate into more horsepower delivered to the generator and more electricity being produced. The further the channels are extended away from the front ambient air scoop, but not so far as to increase parasitic drag, will increase the laminar velocity within the channels and deliver a smoother, less turbulent air flow to the turbine blades, provided the laminar air flow is not disturbed and drag is reduced.

FIG. 7 is a plan view of the lower horizontal channels as viewed in FIG. 3 as well as from another angle in FIGS. 8 and 9. As shown, the hub 10 and shaft 11 are located in the center and connect to the generator and center of the turbine as described above. As described previously, the shaft 11 may maintain a minimum of three inches (3″) separation from the horizontal channel structure and be insulated with rubber or other insulating materials to prevent lightning strikes to the other parts of the other superstructures from reaching the shaft, generator and other electrical equipment.

Adjustable directional deflectors 8 may be located in each section or cord of the arc. Eight individual channels are shown in the lower horizontal channel 14 which delivers equal amounts of accelerated ambient wind to the eight rear exhausts to the turbine blades through the adjustable directional deflectors 8. Although eight individual channels are shown, this is by way of example only and there may be more than eight individual channels or less than eight individual channels. The deflectors 8 may be adjustable to allow for optimum directional flow of the airstream for any particular wind conditions encountered in different locals and wind farms.

Also shown in FIG. 7 is an extension of the horizontal laminar air flow channels 33. The upper and lower horizontal channels 13, 14 may be extended toward the front air scoop 2 to increase and smooth-out the laminar flow of the accelerated ambient air stream reducing turbulences and eddies that may cause losses in the force exerted at the turbine blades 16. This extension may increase the velocity and force on the turbine blades 16 which may translate into more horsepower delivered to the generator and more electricity being produced. The further the channels are extended away from the front ambient air scoop, but not so far as to increase parasitic drag, will increase the laminar velocity within the channels and deliver a smoother, less turbulent air flow to the turbine blades, provided the laminar air flow is not disturbed and drag is reduced.

FIG. 8 is a longitudinal elevation view of pitch control of blades at the start of rotation at +/−75 degrees, according to one aspect. FIG. 9 is a longitudinal elevation view of pitch control of blades at +/−13 degrees, according to one aspect. As shown in FIGS. 8 and 9, main blade bearings and shafts 25 may be located as close to the middle of the airfoil blades as needed to allow the blades to rotate and change pitch and angle of attack from +/−75 degrees at start-up to +/−13 degrees at max RPM. The aerodynamic airfoil type turbine blades 16 may be designed to be comparable to NACA 6409 airfoils which are designed specifically for low wind speed characteristics. The airfoil blades 16 may be mounted at the center as to allow rotation and supported on shaft bearings 25. The airfoil blades 16 may be connected together so that by rotating the shaft of one blade, all the others that are connected to that blade may rotate equally. The pitch angle may begin at +/−75 degrees in relation to the horizontal with a very high angle of attack at start-up and lower to +/−13 degrees as the speed of the turbine disk increases up to maximum RPM for the most optimum use of the accelerated wind stream exiting the channel outlet.

Upper and lower blade connector rods (push rods) 26, 27 may be connected close to the top and bottom of the airfoil blades 16 so that when one blade is rotated by the pitch control rods, then all the other blades that are connected together shall change pitch and angle of attack equally.

As described previously, adjustable airstream deflectors 8 may be are located at the top of the outlet from the laminar flow channels. The deflectors may be adjusted to deliver the accelerated wind stream to the blades 16 at the best possible angle to deliver the most force to the rotating airfoil blades.

One or more of the components and functions illustrated in the FIGS. may be rearranged and/or combined into a single component or embodied in several components without departing from the present disclosure. Additional elements or components may also be added without departing from the present disclosure.

While certain exemplary embodiments have been described and shown in the accompanying drawings, it is to be understood that such embodiments are merely illustrative of and not restrictive on the broad present disclosure, and that this present disclosure may not be limited to the specific constructions and arrangements shown and described, since various other modifications are possible. Those skilled, in the art will appreciate that various adaptations and modifications of the just described preferred embodiment can be configured without departing from the scope and spirit of the present disclosure. Therefore, it is to be understood that, within the scope of the appended claims, the present disclosure may be practiced other than as specifically described herein.

1. A horizontally channeled vertical axis turbine, comprising:
an ambient wind scoop structure comprising an air scoop for gathering ambient wind and increasing the velocity of the ambient wind;
a horizontal laminar flow channel support structure for receiving the gathered ambient wind, comprising:
an upper laminar air-flow channel having an upper inlet and an upper outlet, the upper inlet configured to receive a first portion of the gathered ambient wind from the air scoop; and
a lower laminar air-flow channel having a lower inlet and a lower outlet, the lower inlet configured to receive a second portion of the gathered ambient wind from the air scoop; and
a self-supporting turbine disk structure, comprising:
a shaft bearing;
a shaft having an upper end and an opposing lower end, the lower end attached to extending perpendicularly upward from the shaft bearing;
a hub secured to the upper end of the shaft;
a plurality of trusses having a first end and an opposing second end secured to, the first end connected to and extending horizontally outward from the hub;
a plurality of turbine blades, a turbine blade located at the second end of each truss in the plurality of trusses; and
a gearing assembly located on the shaft for securing a generator to the shaft.

2. The horizontally channeled vertical axis turbine of claim 1, wherein a cross-sectional area of the upper laminar air-flow channel progressively decreases from the upper inlet and the upper outlet; and wherein a cross-sectional area the lower laminar air-flow channel progressively decreases from the lower inlet and the lower outlet.

3. The horizontally channeled vertical axis turbine of claim 1, wherein the ambient wind scoop structure further comprises an adjustable front airfoil located on top of the ambient wind scoop for deflecting non-gathered ambient wind above air scoop creating a low-pressure area above the turbine blades.

4. The horizontally channeled vertical axis turbine of claim 1, wherein the self-supporting channel structure further comprises an adjustable rear airfoil to reduce turbulence at the rear of the turbine which can interfere with a smooth exhaust above the turbine.

5. The horizontally channeled vertical axis turbine of claim 1, wherein the self-supporting channel structure further comprises one or more upper roll-up throttle doors to regulate and control wind speed through the upper laminar air-flow channel to outlets at the front turbine blades at the front half of the wind turbine.

6. The horizontally channeled vertical axis turbine of claim 1, wherein the self-supporting channel structure further comprises one or more lower roll-up throttle doors to regulate and throttle wind speed through the lower laminar air-flow channel to an outlet at the leeward or rear turbine blades at the rear half of the wind turbine.

7. The horizontally channeled vertical axis turbine of claim 1, wherein the upper laminar air-flow channel comprises a plurality of individual upper channels; and wherein the lower laminar air-flow channel comprises a plurality of individual lower channels.

8. The horizontally channeled vertical axis turbine of claim 7, wherein the plurality of turbine blades is formed in a circular configuration having a front half and a rear half where the rear half is located 180 degrees from the front half;
wherein each individual upper channel in the plurality of upper channels directs the gathered ambient wind to a front half of the plurality of turbine blades; and
wherein each individual lower channel in the plurality of lower channels directs the gathered ambient wind to a rear half of the plurality of turbine blades.

9. The horizontally channeled vertical axis turbine of claim 1, wherein each turbine blade in the plurality of turbine blades have an equal amount of force exerted at the same time.

10. The horizontally channeled vertical axis turbine of claim 1, wherein the self-supporting channel structure further comprises:
one or more first adjustable directional deflectors located at the upper outlet of the upper laminar air-flow channel below the plurality of turbine blades; and
one or more second adjustable directional deflectors located at the lower outlet of the lower laminar air-flow channel below the plurality of turbine blades.

11. The horizontally channeled vertical axis turbine of claim 1, wherein the self-supporting channel structure further comprises:
an expansion ring locate above the upper and lower laminar air-flow channels and the plurality of turbine blades.

12. The horizontally channeled vertical axis turbine of claim 1, wherein the self-supporting channel structure further comprises:
an expansion ring support and exhaust deflector located within the expansion ring.

13. The horizontally channeled vertical axis turbine of claim 1, wherein the ambient wind scoop structure further comprises a honeycomb airflow straightener located at an inlet to the air scoop.

14. The horizontally channeled vertical axis turbine of claim 13, wherein the ambient wind scoop structure further comprises one or more air turbulence screens located between the honeycomb airflow straightener and the inlet to the air scoop.

15. A horizontally channeled vertical axis turbine, comprising:
an ambient wind scoop structure, comprising:
an air scoop for gathering ambient wind and increasing the velocity of the ambient wind; and
an adjustable front airfoil located on top of the ambient wind scoop;
a horizontal laminar flow channel support structure for receiving the gathered ambient wind, comprising:
an upper laminar air-flow channel having an upper inlet and an upper outlet, the upper inlet configured to receive a first portion of the gathered ambient wind from the air scoop; and
a lower laminar air-flow channel having a lower inlet and a lower outlet, the lower inlet configured to receive a second portion of the gathered ambient wind from the air scoop;
wherein a cross-sectional area of the upper laminar air-flow channel progressively decreases from the upper inlet and the upper outlet; and wherein a cross-sectional area the lower laminar air-flow channel progressively decreases from the lower inlet and the lower outlet; and
a self-supporting turbine disk structure, comprising:
a shaft bearing;
a shaft having an upper end and an opposing lower end, the lower end attached to extending perpendicularly upward from the shaft bearing;
a hub secured to the upper end of the shaft;
a plurality of trusses having a first end and an opposing second end secured to, the first end connected to and extending horizontally outward from the hub; and
a plurality of turbine blades, a turbine blade located at the second end of each truss in the plurality of trusses.

16. The horizontally channeled vertical axis turbine of claim 15, wherein the self-supporting channel structure further comprises one or more lower roll-up throttle doors to regulate and throttle wind speed through the lower laminar air-flow channel to an outlet at the leeward or rear turbine blades at the rear half of the wind turbine.

17. The horizontally channeled vertical axis turbine of claim 15, wherein the upper laminar air-flow channel comprises a plurality of individual upper channels; and wherein the lower laminar air-flow channel comprises a plurality of individual lower channels.

18. The horizontally channeled vertical axis turbine of claim 17, wherein the plurality of turbine blades is formed in a circular configuration having a front half and a rear half where the rear half is located 180 degrees from the front half;
wherein each individual upper channel in the plurality of upper channels directs the gathered ambient wind to a front half of the plurality of turbine blades; and
wherein each individual lower channel in the plurality of lower channels directs the gathered ambient wind to a rear half of the plurality of turbine blades.

19. The horizontally channeled vertical axis turbine of claim 15, wherein each turbine blade in the plurality of turbine blades have an equal amount of force exerted at the same time.

20. The horizontally channeled vertical axis turbine of claim 15, wherein the self-supporting channel structure further comprises:
one or more first adjustable directional deflectors located at the upper outlet of the upper laminar air-flow channel below the plurality of turbine blades; and
one or more second adjustable directional deflectors located at the lower outlet of the lower laminar air-flow channel below the plurality of turbine blades.
